(19) United States
(12) Patent Application Publication
(10) Pub. No.: US 2008/0034092 A1
(43) Pub. Date: Feb. 7, 2008

(54) Access control system and access control server

(76) Inventors: Satoshi Kikuchi, Yokohama (JP); Takashi Tsunehiro, Ebina (JP); Toui Miyawaki, Kawasaki (JP); Emiko Kobayashi, Yokohama (JP)

Correspondence Address: MCDERMOTT WILL & EMERY LLP, 600 13TH STREET, N.W., WASHINGTON, DC, 20005-3096, US

(21) Appl. No.: 11/822,544

(22) Filed: Jul. 6, 2007

(30) Foreign Application Priority Data
Jul. 6, 2006 (JP) 2006-186189

(51) Int. Cl. G06F 15/173

(52) U.S. Cl. 709/225

(57) ABSTRACT

An access control system and an access control server using Terminal Services or the like, which prevents information from being leaked are provided. The access control system includes one or more computer units, one or more terminals, and the access control server that controls a hub. The one or more terminals are coupled with the one or more computer units through a network and the hub. The hub controls access from the one or more terminals to the one or more computer units. In accordance with the result of the authentication, the access control server authenticates a user who operates one of the terminals and sets the hub so that a network link for a particular protocol is established between the terminal operated by the user and a particular one of the computer units.

### INCORPORATION BY REFERENCE

This application claims priority based on a Japanese patent application, No. 2006-186189 filed on Jul. 6, 2006, the entire contents of which are incorporated herein by reference.

### BACKGROUND OF THE INVENTION

The present invention relates to an access control system and an access control server, which are suitable for Terminal Services.

With the recent proliferation of the Internet, there is a demand that various tasks (hereinafter referred to as PC activities) using a computer, such as an email, web page, and creation of a document, are able to be performed from anywhere including home and a location outside home. To achieve the above, a terminal accesses a computer (remote computer) via a network so that the desktop screen of the computer is displayed on a screen of the terminal to perform a task. Such a system has been in practical use, which is called Terminal Services in general. For Terminal Services, all created data and software including an OS (operating system) and applications used for PC activities are stored in a secondary storage device such as a hard disk provided in a remote computer. Each software program is executed by a central processing unit (CPU) provided in the remote computer. A terminal, which is directly operated by a user, transmits control information input from a user interface device such as a keyboard or a mouse to the remote computer and displays information (which is transmitted from the remote computer) on a desktop screen on a display of the terminal.

There are two types of Terminal Services: Peer to Peer (P2P) type in which a single user exclusively uses a single remote computer, which is called a remote desktop function; and Server Based Computing (SBC) type in which multiple users share a single remote computer. For SBC type, the remote computer is also called a terminal server.

When a user starts a PC activity, the user uses a terminal to request a connection to a remote computer. In this case, the remote computer performs user authentication to verify an identification of the user, that is, to verify if the user is permitted to access the remote computer, in order to prevent unauthorized access from a third party. To perform user authentication, a technique for verifying an identification of a user by use of a combination of a user ID with a password has been widely used. When receiving the request for connection, the remote computer displays a login screen to verify if the combination of a user ID and a password which are entered by the user matches the combination of a user ID and a password which are pre-registered. When they match each other, the remote computer permits the request for connection (login) and provides Terminal Services to the terminal of the user. If they do not match each other, the remote computer rejects the request for connection.

In view of convenience and security upon the user authentication and upon the connection to Terminal Services, connection techniques using a storage medium such as an IC card have been proposed. For example, JP-A-2001-282747 discloses one of the connection techniques. In the technique described in JP-A-2001-282747, a storage medium (IC card), which stores first information required for coupling a terminal with a server through a network and second information required for authenticating a user, is inserted in the terminal; matching is performed between information entered by the user and the second information stored in the storage medium; if they match each other, the terminal is coupled to the server by use of the first information that is read out from the storage medium.

In addition, techniques for preventing unauthorized use of a system have been proposed. For example, U.S. Pat. No. 6,907,470 discloses the following technique: user authentication is performed when a file server is accessed, and network devices are controlled so that communication packets transmitted from a terminal, which is operated by a user who has been successfully authenticated, are relayed, and so that communication packets from other terminals are discarded.

Furthermore, when a company outsources their own jobs to another company, customer information and know-how of the jobs may be provided from the outsourcing company to the outsourced company, and information on the jobs such as customer data may be illegally copied, obtained, and used by use of the above techniques. For example, JP-A-2005-242926 discloses a technique for preventing those illegal actions.

Recently, leaks of company information such as customer information have occurred. The leaks have resulted in considerable losses for companies, such as compensation for damage and loss of social credibility.

Based on the abovementioned techniques, as long as a user performs activities using Terminal Services, security is ensured since no information is left in the terminal of the user. However, an information sharing server such as a web server and a mail server are coupled to the intranet. Thus, if the terminal accesses the above server(s), information can be downloaded to the terminal and copied to a removable medium such as a floppy disk. Therefore, there is still a risk that information may be leaked by a malicious user.

### SUMMARY OF THE INVENTION

The present invention provides an access control system and an access control server, which prevent unauthorized access (e.g., password attack) to a computer, in the case of using Terminal Services or the like.

In addition, the present invention provides an access control system and an access control server, which prevent information from being leaked, in the case of using Terminal Services or the like.

Furthermore, the present invention provides an access control system which prevents information from being leaked intentionally and negligently.

Specifically, in the access control system, a hub is provided serving as a firewall to block protocols such as HTTP and POP other than a particular protocol which is permitted to be used. With the configuration, access control is possible so that only remote computers in the intranet are permitted to access a web server and a mail server and that a user terminal is not permitted to directly access the web server and the mail server.

According to an aspect of the present invention with the above configuration, the access control system is configured so that: one or more computer units, one or more terminals, and an access control server are provided; the one or more computer units are coupled with the one or more terminals through a network and the hub; the access control server controls the hub; and the hub controls access from the one or more terminals to the one or more computer units. The access control server performs authentication of a user who operates any of the one or more terminals. The access control server sets the hub so that, in accordance with the result of the user authentication, a network link for the particular protocol is established between the terminal operated by the user and a particular one of the one or more computer units.

In addition, the access control server may control start of the computer unit based on the result of the user authentication.

Furthermore, the access control system may be configured so that: when the access control server determines that the user is legitimate based on the user authentication, the access control server provides, to the terminal, a control screen which allows the user to control operations of the computer unit; the terminal displays the control screen and receives an instruction from the user to transmit the instruction to the access control server; and the access control server controls the start of the computer unit based on the instruction from the user.

Furthermore, the access control server may be configured so that it determines a communication port number to be assigned to the particular protocol and sets, in the hub, access permission of the communication port number that has been determined for establishment of the network link for the particular protocol.

Furthermore, the access control system may be configured so that: the computer unit selects a communication port number used for the network link and notifies the access control server of the communication port-number; and the access control server sets, in the hub, access permission of the communication port number (which has been notified from the computer unit) as the communication port number to be assigned to the particular protocol for establishment of the network link for the particular protocol.

Furthermore, the computer units may randomly select the communication port number to be notified.

Furthermore, the access control server may be configured so that it determines a location where a terminal is coupled with a network based on an address assigned to the network to which the terminal is coupled and that it determines the communication port number to be assigned to the particular protocol of the network link based on the location that has been determined for establishment of the network link for the particular protocol.

Furthermore, the access control server may monitor an event occurring in the computer unit, and when detecting an occurrence of a predetermined event, it may set the hub so that the network link between the computer unit and the terminal operated by the user is released.

The present invention provides an access control system capable of preventing unauthorized access from persons other than legitimate users and securely protecting user data.

In addition, the present invention provides an access control system useful for preventing company information from being leaked.

These and other benefits are described throughout the present specification. A further understanding of the nature and advantages of the invention may be realized by reference to the remaining portions of the specification and the attached drawings.

### DESCRIPTION OF THE DRAWINGS

FIG. 1 is a diagram showing the configuration of a computer system performing access control services according to a first embodiment of the present invention.

FIG. 2 is a diagram showing an example of the logical configuration of an access control server 3 shown in FIG. 1.

FIG. 3 is a diagram showing an example of contents of information stored in the management database 10 shown in FIG. 2.

FIG. 4 is a diagram showing an example of information (ACE) indicating permission or denial of the relay, the ACE being set by the access control server 3 shown in FIG. 2.

FIG. 5 is a diagram showing a series of communication sequences between the devices shown in FIG. 1.

FIG. 6 is a flow chart showing an example of a connection process.

FIG. 7 is a flow chart showing an example of an interruption process.

FIG. 8 is a flow chart showing an example of a termination process.

FIG. 9 is a diagram to explain a function for access control performed in the configuration shown in FIG. 1

FIG. 10 is a diagram showing a modified example of the configuration shown in FIG. 1.

FIG. 11 is a diagram showing an example of the internal configuration of a terminal 1 shown in FIG. 1.

FIG. 12 is a diagram showing an example of the internal configuration of the access control server 3 shown in FIG. 1.

FIG. 13 is a diagram showing a modified example of the communication sequences shown in FIG. 5.

FIG. 14 is a diagram showing another modified example of the communication sequences shown in FIG. 5.

FIG. 15 is a diagram showing an example of the internal configuration of a computer unit 2 shown in FIG. 1.

FIG. 16 is a diagram showing a modified example of ACEs.

FIG. 17 is a diagram showing another modified example of ACEs.

FIG. 18 is a diagram showing an example of contents of information included in a disconnection event list.

FIG. 19 is a flow chart showing an example of an event detection process.

FIG. 20 is a diagram showing another modified example of the communication sequences shown in FIG. 5.

FIG. 21 is a diagram showing an example of a control screen that is provided to the terminal 1 by the access control server 3.

FIG. 22 is a diagram showing an example of a data edition in the control screen that is provided to the terminal 1 by the access control server 3.

### DETAILED DESCRIPTION OF THE EMBODIMENTS

A description will be made of embodiments of an access control system and an access control server according to the present invention with reference to the accompanying drawings.

### First Embodiment

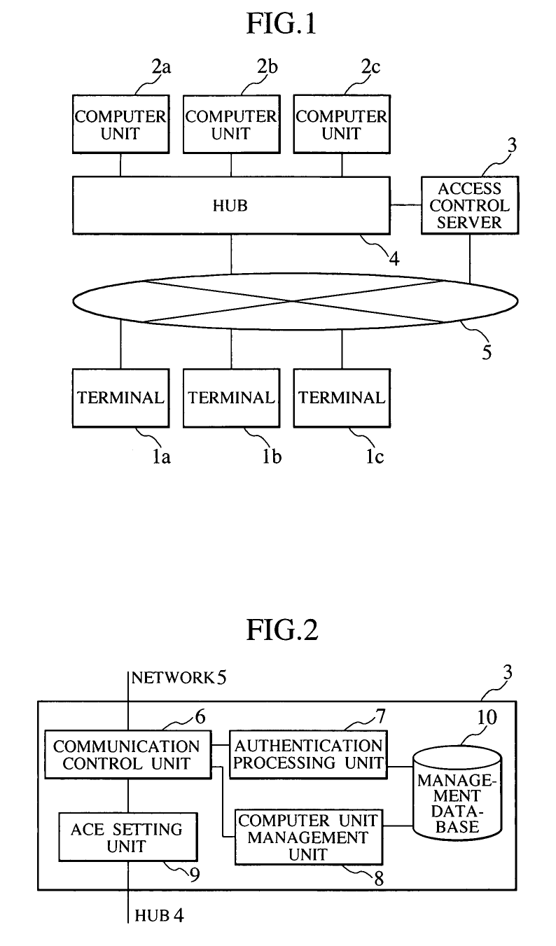

FIG. 1 is a diagram showing the configuration of an access control system according to a first embodiment of the present invention. One or more terminals 1 (1a, 1b, 1c) (three terminals are provided in this example) are coupled to a network 5 such as a local area network (LAN). One or more computer units 2 (2a, 2b, 2c) (three computer units are provided in this example) are coupled to the network 5 through a hub device (hereinafter referred to as a hub) 4. An access control server 3 is coupled to the network 5. Also, the access control server 3 is directly coupled with a management port of the hub 4. A user operates any one of the terminals 1 to access a particular one of the computer units 2 so that P2P type Terminal Services is provided to the terminal 1 operated by the user. Each of the terminals 1 and the access control server 3 may be coupled to the network 5 through a network device such as a repeater hub, a switching hub, and a switching device.

Each of the computer units 2 is a remote computer provided with software including, for example, an operating system (OS) and application software used for business activities, a secondary storage device such as a hard disk for storing created data, and a CPU for executing each software program.

The hub 4 is a network device having a relay function to transmit, to a computer, a communication packet that has been received from another computer. Also, the hub 4 has a filtering function for relaying communication packets to a computer specified as relay destinations in the communication packets and for blocking relay to computers other than computers specified as relay destinations in communication packets. That is, the filtering function is designed to relay communication packets only to the computers specified as relay destinations in the communication packets. A general purpose switching hub, switch, bridge and the like may be applicable to the hub 4.

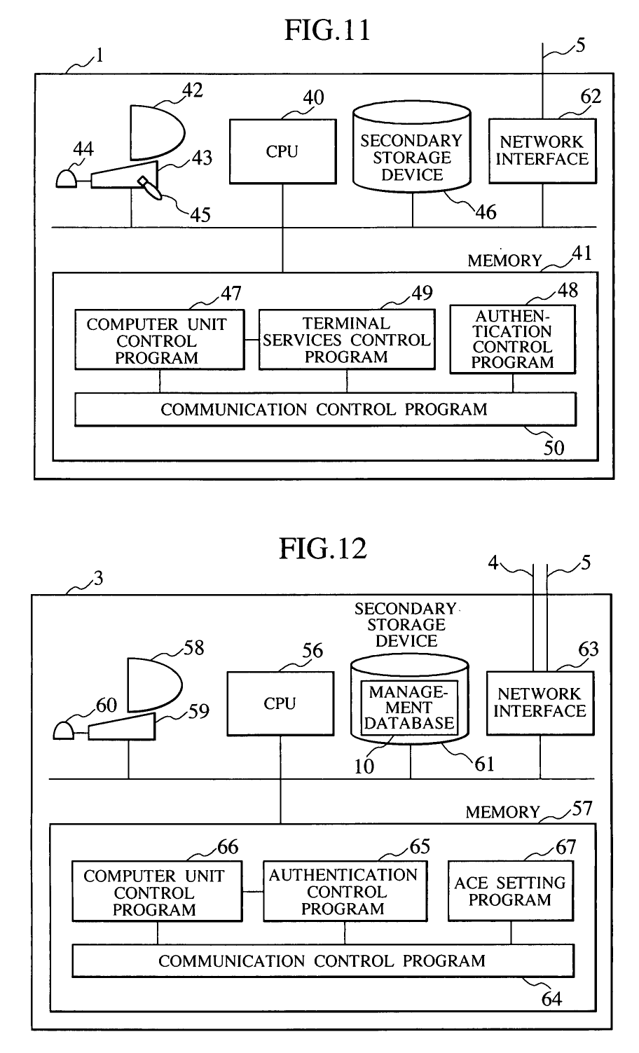

FIG. 11 is a diagram showing an example of the internal configuration of the terminal 1 according to the present embodiment.

The terminal 1 is a computer having the following devices coupled with each other by use of internal communication lines: a CPU 40; a memory 41; display 42; a user interface device (a keyboard 43, a mouse 44 and the like); a secondary storage device 46 (a hard disk, a flash memory, and the like); a network interface 62 (a LAN card or the like which transmits/receives data to/from another computer via a network); and an interface for an authentication device 45 (such as an IC card) used to verify an identification of a user. The memory 41 stores various programs.

The various programs are stored in the secondary storage device 46 and transferred to the memory 41 so as to be executed by the CPU 40 when necessary. The programs may be pre-stored in the secondary storage device 46. Also, the programs may be read out from a communication medium or a removable storage medium via the network interface 62 and a storage medium reading device (not illustrated) so as to be stored in the secondary storage device 46 when necessary. It should be noted that the communication medium is the network 5 and a carrier wave or a digital signal which propagates in the network 5.

A communication control program 50 allows a communication control unit 50 to communicate with another computer through the network interface 62. A computer unit control program 47 allows a computer unit control program 47 to communicate with the access control server 3. An authentication control program 48 allows an authentication control unit 48 to generate information indicating the identification of the user. The identification is verified by the authentication device 45. A terminal services control program 49 allows a terminal services control unit 49 to transmit control information that is entered by use of the user interface device to a particular one of the one or more computer units 2 and to cause the display 42 to display information on a desktop screen. The information on the desktop screen is transmitted from the particular computer unit 2. It should be noted that the same reference number is used for each program and each control unit that operates with a corresponding one of the programs, as described above.

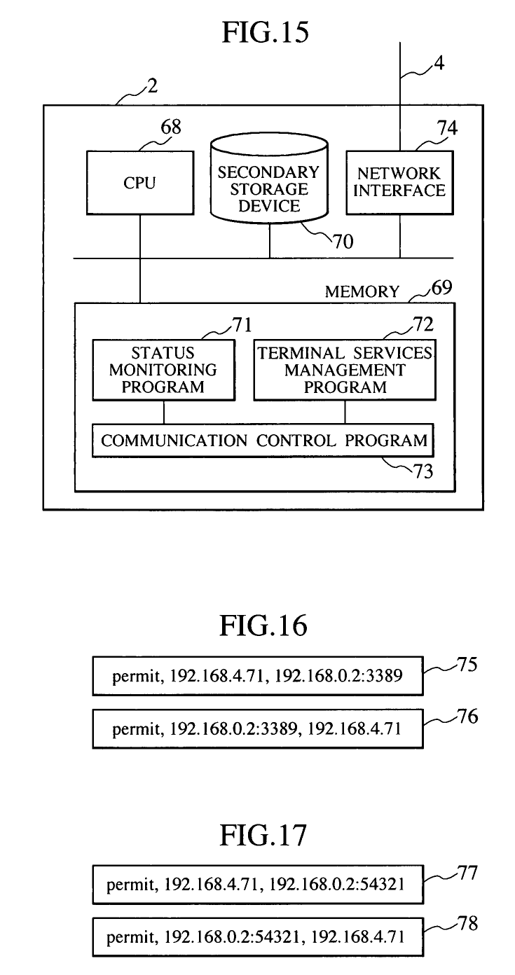

FIG. 15 is a diagram showing an example of the internal configuration of the computer unit 2 according to the present embodiment.

Each of the computer units 2 is a computer provided with: software including, for example, an OS and application software used for business activities; a secondary storage device 70 such as a hard disk for storing created data and the like; a CPU 68 for executing each software program; a memory 69; and a network interface 74. The memory 69 stores various programs.

The programs are firstly stored in the secondary storage device 70 and then transferred to the memory 69 so as to be executed by the CPU 68 when necessary. The programs may be pre-stored in the secondary storage device 70. Also, the programs may be read out from a communication medium or removable storage medium via the network interface 74 and a storage medium reading device (not illustrated) so as to be stored in the secondary storage device 70 when necessary. It should be noted that the communication medium is the network 5 and a carrier wave or a digital signal which propagates in the network 5.

A communication control program 73 allows a communication control unit to communicate with another computer through the network interface 74. A status monitoring program 71 allows a status monitoring unit to monitor the status of the computer unit 2 and notify the access control server 3 of the status. A terminal services management program 72 allows a terminal services management unit to receive control information entered from the user interface device of the terminal 1 and transmit information on a desktop screen to the terminal 1. The status monitoring program 71 and the terminal services management program 72 start to be executed when the computer unit 2 is started and continue to be executed until the computer unit 2 is shut down.

The access control server 3 determines whether to permit or deny a relay of a communication packet between a certain terminal and a certain computer unit (i.e., whether to establish a network link between them) and issues a setting command to the hub 4.

The network link will be described below. Each of the one or more terminals 1 is physically coupled with each of the one or more computer units 2. The network link according to the present embodiment is a logical communication channel established over a network and between a particular one of the one or more terminals 1 and a particular one of the one or more computer units 2. Application programs installed in the terminal 1 and in the computer unit 2 allow application data to be transmitted and received through the network by use of the established communication channel. According to the Open Systems Interconnection (OSI) Reference Model, the communication channel according to the present embodiment is established in layers (the transport layer in the TCP (Transmission Control Protocol) and the like and the network layer in the IP (Internet Protocol) and the like) lower than the application layer. The lower layers in which the communication channel is established provide a communication function.

If the communication channel (or the network link) according to the present embodiment is not established in the lower layers, communications such as communications with Terminal Services in the application layer cannot be performed. In other words, on the network link, a communication packet is transmitted only between the terminals 1 for which user authentication has succeeded and the computer units 2 which have been specified by the access control server 3. Otherwise, a communication packet is not transmitted.

In addition, the network link according to the present embodiment is a dynamic communication channel, which is established only when the user uses the network link. When all the users use network links, the network links corresponding to the number of the users are established.

FIG. 12 is a diagram showing an example of the hardware configuration of the access control server 3 according to the present embodiment.

The access control server 3 has a CPU 56, a memory 57, a display 58, a user interface device (keyboard 59, mouse 60 and the like), a secondary storage device 61 (a hard disk or the like), and a network interface 63 used to transmit/receive data to/from another computer and the hub 4 through the network 5.

The memory 57 stores various programs, and the secondary storage device 61 stores a management database 10. These programs are stored in the secondary storage device 61 and transferred to memory 57 so as to be executed by the CPU 56 when necessary. This achieves a logical configuration shown in FIG. 2. These programs may be pre-stored in secondary storage device 61. Also, the programs may be read out from a communication medium or a removable storage medium via the network interface 63 and a storage medium reading device (not illustrated) so as to be stored in the secondary storage device 61 when necessary. It should be noted that the communication medium is the network 5 and a carrier wave or a digital signal which propagates in the network 5.

FIG. 2 is a diagram showing an example of the logical configuration of the access control server 3 according to the present embodiment, which is achieved based on the abovementioned configuration.

A communication control program 64 allows a communication control unit 6 to communicate with a particular one of the one or more terminals 1, another computer and the hub 4 through the network interface 63 and the network 5. An authentication processing program 65 allows an authentication processing unit 7 to verify an identification of a user and perform user authentication. A computer unit management program 66 allows a computer unit management unit 8 to start and shut down the one or more computer units 2. An access control entry (ACE) setting program 67 allows an ACE setting unit 9 to issue, to other hub 4, data indicating an addition or removal of an access control entry (ACE) for permission or denial of a relay of a communication packet and to establish the network link. The management database 10 stores management information on the users and the computer units 2 and is used to associate a particular user with a particular one of the computer units 2.

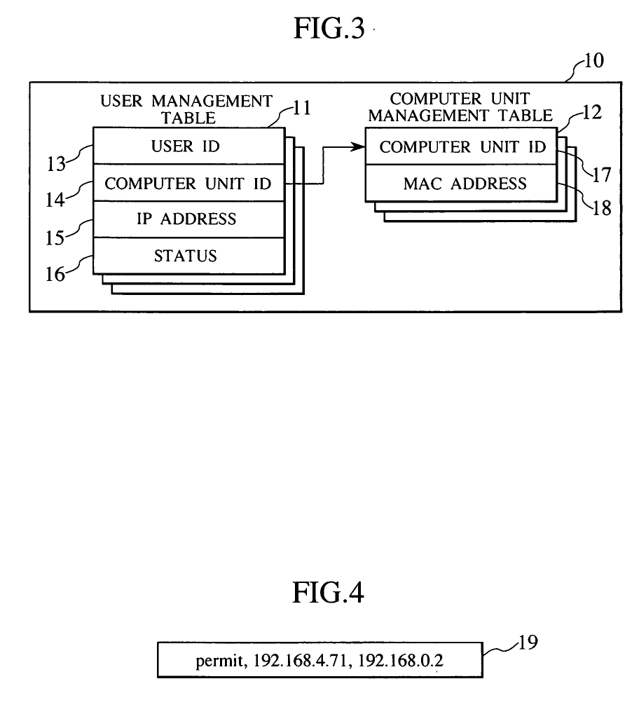

FIG. 3 is a diagram showing an example of contents of information stored in the management database 10. A user management table 11 stored in the management database 10 stores management information on the user. A computer unit management table 12 stored in the management database 10 stores management information on the computer unit 2.

The user management table 11 has arrays (user entries) whose number corresponds to the number of the users using the computer units 2. Information stored in each user entry includes: a user ID 13 which uniquely identifies a user; an ID 14 of a particular computer unit 2 which is used by the user; an IP address 15 assigned to the computer unit 2; a status 16 (operating status, connection/interruption/termination) which indicates the status of the computer unit 2; and the like. The status 16 is initialized when the computer unit 2 is shut down. The information items other than the status 16 are set with system administrator's privilege.

The computer unit management table 12 has arrays (computer unit entries) whose number corresponds to the number of the computer units 2 which are used and provided in the access control system. Information stored in each user entry includes: a computer unit ID 17 (name, number, etc.) which uniquely identifies one of the computer units 2; an MAC address 18 which is used when the computer unit 2 is started; and the like. The information items are set with the system administrator's privilege. It should be noted that the arrangement of the information items stored in the management database 10 is not limited to this example. For example, although the IP address 15 is included in the user management table 11 since it is information registered in an OS, it may be included in the computer unit management table 12 by regarding it as information associated with the computer unit 2.

An association of a particular user with a particular one of the computer units 2, that is, an association of the individual user entries with the individual computer unit entries is performed by setting a value, which is set for the computer unit ID 17 of the computer unit entry, for the user ID 14 of the user unit entry.

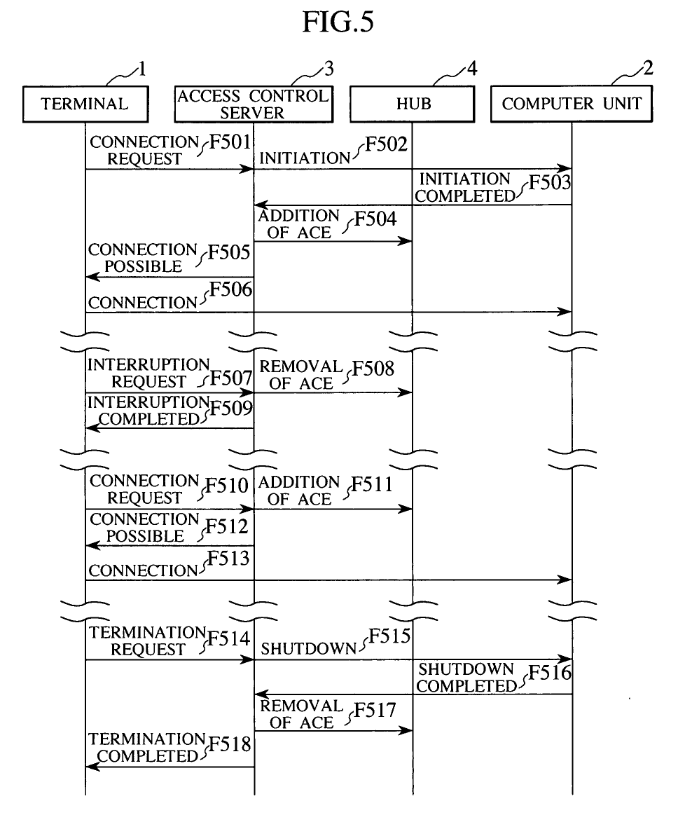

FIG. 4 is a diagram showing an example of information (ACE) indicating permission or denial of the relay, the ACE being set to the hub 4 by the access control server 3. The ACE includes three parts (first, second and third parts), which are separated by comma. The first part indicates permission or denial of the relay. The word “permit” indicates permission of the relay while the word “deny” indicates denial of the relay. The second and third parts each specify a communication packet for which access control is to be performed. The second part indicates a source address (IP address assigned to a transmitting computer), and the third part indicates a destination address (IP address assigned to a receiving computer). An ACE 19 shown in FIG. 4 indicates permission of the relay of a communication packet transmitted from an IP address “192.168.4.71” to an IP address “192.168.0.2”.

A plurality of ACEs can be set in the hub 4. A list of the ACEs is called an access control list (ACL). In general, for the hub 4, a search priority can be specified when an ACE is added to the ACL. There are some methods for specifying the search priority. One method is to insert an ACE as an Mth ACE from the top or insert an ACE as an Nth ACE from the bottom, and another method is to provide a search priority number to an ACE to be added. When the hub 4 receives a communication packet, it reads ACEs inserted in the ACL in accordance with the search priority to verify if a source address and destination address in each of the ACEs match a source address and a destination address which are described in the communication packet. When the hub 4 detects an ACE having the addresses that coincide with those described in the communication packet, it refers to the first part of the detected ACE to relay or block the communication packet in accordance with an instruction (permit or deny) indicated in the first part. If the hub 4 cannot detect an ACE having the addresses that coincide with those described in the communication packet, a default ACE is used for the communication packet. In the default ACE, there is a data description only in the first part (permit or deny). According to the present embodiment, communications between IP addresses that are not set in the ACEs can be blocked by setting “deny” in the first part of the default ACE by the system administrator before the access control system operates.

The access control server 3 according to the present embodiment transmits, to a certain one of the computer units 2, a communication packet called a magic packet which requests the computer unit 2 to be started. The magic packet is described later. In order to transmit this packet through the hub 4, the following ACE may be preset in the hub 4: an ACE having a first part indicating “permit”, a second part indicating an IP address assigned to the access control server 3 and a third part indicating no IP address. If there is no IP address in the second or third parts, the hub 4 determines that a transmitting computer or a receiving computer is not specified. In the case of the abovementioned ACE, all communication packets transmitted by the access control server 3 are relayed irrespective of which computer unit is a destination. In addition, if there is a communication packet to be transmitted to the access control server 3 from the computer unit 2, the following ACE may be added to the hub 4 before the transmission: an ACE having a first part indicating “permit”, a second part indicating no IP address, and a third part indicating the IP address assigned to the access control server 3.

Next, a flow of a process for access control services according to the present embodiment will be described.

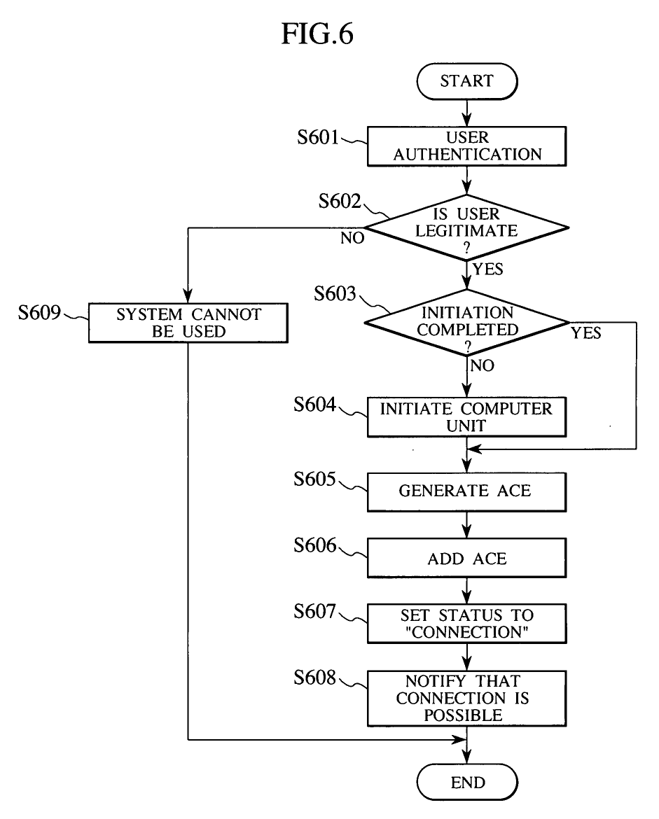

FIG. 5 is a diagram showing a series of communication sequences between the devices. FIGS. 6 through 8 show flow charts of a connection process, interruption process, and termination process of the access control server 3, respectively. It should be noted that the “connection” means the state where the terminal 1 and the computer unit 2 can communicate with each other and that the “interruption” means the state where the terminal 1 and the computer unit 2 cannot communicate with each other.

First, a description will be made of a process for connecting the terminal 1 to the computer unit 2 by operating the terminal 1 by the user with reference to FIGS. 5 and 6.

The user operates the computer unit control program 47 of the terminal 1 to transmit a connection request (F501) to the access control server 3. The communication control unit 6 of the access control server 3 receives the connection request (F501) and requests the authentication processing unit 7 to perform user authentication.

According to the present embodiment, Transport Layer Security (TLS) protocol is used to perform user authentication. The TLS protocol has been standardized by Internet Engineering Task Force (IETF) which is the Internet standardization organization. TLS is a technique which is widely known as Secure Sockets Layer (SSL). In addition, the TLS protocol is used to verify an identification of a user by using a public key encryption technique and a public key certificate which guarantees validity of the public key. The public key encryption technique is to encrypt and decrypt-data with a public key and a secret key. Also, the TLS protocol is used to encrypt communication data. Server authentication and client authentication are defined by the TLS protocol. The server authentication is to verify an identification of a server, whereas the client authentication is to verify an identification of a client. In the case of using the client authentication, each user has his/her own public key, secret key and public key certificate, which may be stored in the secondary storage device 46 of the terminal 1 or may be stored in the authentication device 45 (IC card or the like) capable of securely storing a key.

The authentication processing unit 7 verifies the identification of the user who operates the terminal 1 by use of TLS client authentication described above (S601). As a result of the verification, if the authentication processing unit 7 verifies that the user is legitimate, it returns, to the communication control unit 6, a subject name included in the public key certificate of the user. The communication control unit 6 passes the subject name to the computer unit management unit 8 to request start of the computer unit 2 (S602).

After receiving the request, the computer unit management unit 8 searches the user management table 11 in the management database 10 to find a user entry that is registered in the user ID 13 and that has the same value as the subject name that has been passed. When the computer unit management unit 8 finds the user entry, it refers to the computer unit ID 14 and the status ID 16 of a particular computer unit 2 used by the user and confirms whether or not the computer unit 2 is started (S603). If the status 16 indicates “termination (the computer unit 2 is not started)”, the computer unit management unit 8 starts the computer unit 2.

According to the present embodiment, in order to start the computer unit 2, a technique called a magic packet is used. The magic packet is a communication packet used to remotely start a computer coupled through a network and specify the computer to be started by using a MAC address specific to a LAN card.

The computer unit management unit 8 retrieves a value of the computer unit ID 14 to search a computer unit entry, which has the same value as the value of the computer unit ID 14 and which is registered in the computer unit ID 17, from the computer unit management table 12. Then, the computer unit management unit 8 retrieves a value registered in a MAC address 18 of the computer unit entry that has been found to create a magic packet including the value (F502) and to transmit it to the computer unit 2 through the network 5 (S604).

The status monitoring unit of the computer unit 2 that has been started detects that the terminal services management unit starts Terminal Services. Then, the status monitoring unit transmits, to the access control server 3, a notification (F503) indicating that the start of the computer unit 2 is completed. When the computer unit management unit 8 confirms the completion of the start, it retrieves a value registered in the IP address 15 within the user entries to notify the communication control unit 6 of the value.

Next, the communication control unit 6 extracts a source address from the communication packet of the connection request (F501) that has been received and passes, to the ACE setting unit 9, the source address and the IP address 15 assigned to the computer unit 2, which has been notified from the computer unit management unit 8. Then, the communication control unit 6 requests the ACE setting unit 9 to add and set an ACE.

After receiving the request from the communication control unit 6, the ACE setting unit 9 generates an ACE as shown in FIG. 4 (S605). Specifically, the ACE has a first part indicating “permit”, a second part indicating the source address included in the communication packet that has been passed and a third part indicating the IP address assigned to the computer unit 2 which has been passed. Next, the ACE setting unit 9 transmits, to the hub 4 through the management port, a request (F504) for additionally setting the generated ACE (S606). This establishes a network link between the terminal 1 that has requested the connection and the particular computer unit 2 used by the user. After that, the ACE setting unit 9 returns control to the communication control unit 6.

The communication control unit 6 requests the computer unit management 8 to change a value of the status 16 within the user entries so that the status 16 indicates “connection” (S607). Then, the communication control unit 6 returns, to the terminal 1, the IP address 15 assigned to the computer unit 2 which has been notified from the computer unit management unit 8 and a notification (F505) indicating that the connection is prepared and can be established, in response to the connection request (F501) (S608).

When the terminal 1 receives the notification (F505) indicating that the connection can be established, the computer unit control program 47 of the terminal 1 transmits the IP address that has been notified to the terminal services control unit 49. The terminal services control unit 49 uses the IP address to transmit, to the computer unit 2, a request (F506) for connection to Terminal Services. Then, the user enters a user ID and a password on a login screen and then receives Terminal Services to perform PC activities.

In the abovementioned authentication processing (S602), if the authentication processing unit 7 cannot verify the identification of the user who operates the terminal 1, the communication control unit 6 returns, to the terminal 1, a notification indicating the terminal 1 cannot use the system (S609). In addition, the communication control unit 6 does not start any of the computer units 2 and does not set a network link between the terminal 1 and any of the computer units 2.

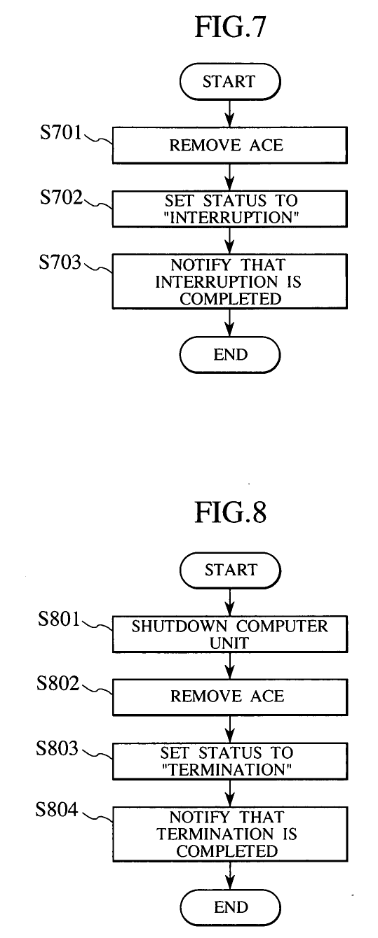

Next, referring to FIGS. 5 and 7, the interruption process used when the user temporarily leaves the terminal 1 will be described. The interruption process is effective to prevent unauthorized access from the terminal 1 operated by another user.

When the user leaves the terminal 1, the user operates the computer unit control program 47 to transmit an interruption request (F507) to the access control server 3. The communication control unit 6 of the access control server 3 receives the interruption request (F507) and requests the ACE setting unit 9 to remove a corresponding ACE.

After receiving the request from the communication control unit 6, the ACE setting unit 9 transmits, to the hub 4 through the management port, a request (F508) for removing the ACE that has been additionally set in the abovementioned connection step (S606). This operation releases the network link (which is currently coupled) set between the terminal 1 and the particular computer unit 2 used by the user, resulting in that communications between them are decoupled. The computer unit 2, however, continues to operate without being shut down. After that, the ACE setting unit 9 returns the control to the communication control unit 6.

Next, the communication control unit 6 requests the computer unit management 8 to change the value of the status 16 within the user entries so that the status 16 indicates “interruption” (S702). Then, the communication control unit 6 returns, to the terminal 1 in response to the interruption request (F507), a notification (F509) indicating that the interruption process has been properly completed (S703).

After that, when the user returns to the terminal 1 to restart PC activities, the same process as that for the connection request described above with reference to FIG. 6 is performed. That is, the user operates the computer unit control program 47 of the terminal 1 to transmit the connection request (F501) to the access control server 3 so that the access control server 3 performs user authentication and sets an ACE again. It should be noted that, since the computer unit 2 is already started (interruption), the step (S604) for starting the computer unit 2 is skipped. When the ACE setting unit 9 transmits, to the hub 4, a request (F511) for adding an ACE that has been generated, the network link is reestablished between the terminal 1 that has been previously interrupted and the particular computer unit 2.

The computer unit control program 47 of the terminal 1 that has received a notification (F512) indicating that the connection can be established starts the terminal services control unit 49. Then, the computer unit control program 47 transmits, to the computer unit 2, a request (terminal services connection request) (F513) for connecting the terminal 1 to Terminal Services. Then, the user performs a login (enters a user ID and a password) to restart PC activities.

Next, referring to FIGS. 5 and 8 a description will be made of the termination process performed when the user terminates PC activities, for example, when the user goes home.

To terminate PC activities, the user operates the computer unit control program 47 of the terminal 1 to transmit a request (F514) for the termination to the access control server 3. The communication control unit 6 of the access control server 3 receives the termination request (F514) and requests the computer unit management unit 8 to shut down the computer unit 2.

After receiving the request, the computer unit management unit 8 transmits a request (F515) for shutting down the computer unit 2 to the computer unit 2 through the network 5 (S801) and waits the completion of the shutdown. When the status monitoring unit of the computer unit 2 detects the start of the shutdown, it transmits, to the access control server 3, a notification (F516) indicating the shutdown is completed. After the computer unit management unit 8 confirms the completion of the shutdown, it returns the control to the communication control unit 6.

The communication control unit 6 requests the ACE setting unit 9 to remove a corresponding ACE. The ACE setting unit 9, which has received the request from the communication control unit 6, issues a request (F517) for removing the ACE (that is currently set) to the hub 4 through the management port (S802). This operation releases the network link set between the terminal 1 (that is currently coupled) and the particular computer unit 2, resulting in that communications between them are decoupled. After that, the ACE setting unit 9 returns the control to the communication control unit 6.

In addition, the communication control unit 6 requests the computer unit management unit 8 to change the value of the status 16 within the user entries so that the status 16 indicates “termination” (S803). Then, the communication control unit 6 transmits, to the terminal 1 in response to the termination request (F514), a notification (F518) indicating that the shutdown is properly completed (S804).

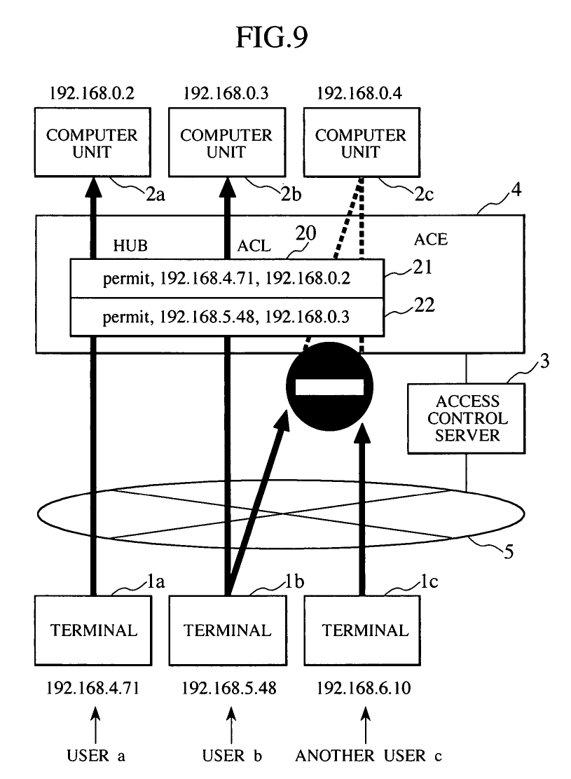

Next, referring to FIG. 9, a description will be made of access control operations according to the present embodiment and effects thereof, that is, a function for preventing unauthorized access.

In this example, three terminal 1a, 1b, 1c and three computer units 2a, 2b, 2c are coupled with the network 5. It is assumed that the IP addresses assigned to the terminals 1a, 1b, 1c are “192.168.4.71”, “192.168.5.48”, and “192.168.6.10”, respectively. On the other hand, it is assumed that the IP addresses assigned to the computer units 2a, 2b, 2c are “192.168.0.2”, “192.168.0.3”, and “192.168.0.4”, respectively. Furthermore, it is assumed that the users a and b operate the terminal 1a and 1b and can use the particular computer units 2a and 2b, respectively.

When the user a operates the terminal 1a to transmit a connection request to the access control server 3, the access control server 3 confirms the identification of the user a and then requests the hub 4 to add an ACE 21 to an ACL 20. This establishes a network link between the terminal 1a and the computer unit 2a so that a communication packet can be transmitted and received between them. As a result, the user a who operates the terminal 1a can receive Terminal Services provided from the computer unit 2a.

Similarly to the terminal 1a, in the case of the terminal 1b, the access control server 3 requests the hub 4 to add an ACE 22. Then, a network link is established between the terminal 1b and the computer unit 2b. As a result, the user b who operates the terminal 1b can receive Terminal Services provided from the computer unit 2b.

The IP address assigned to the terminal 1c for which the access control server 3 does not perform user authentication does not coincide with an IP address included in any of ACEs in the ACL 20. That is, a network link is not established between the terminal 1c and any one of the computer units. Thus, even if another user c operates the terminal 1c, the terminal 1c cannot access any of the computer units. In addition, even a terminal for which the access control server 3 has performed user authentication cannot access computer units other than a particular computer unit. For example, since a network link is not established between the terminal 1b and the computer unit 2c, the terminal 1b cannot access the computer unit 2c. Also, any one of the computer units cannot access another computer unit. For example, after the terminal 2b operated by the user b is coupled to Terminal Services on the computer unit 2b, an attempt to connect to Terminal Services on the computer unit 2c from the computer unit 2b is not successful.

As described above, with the access control system and the access control server according to the present embodiment, a network link in which communications can be performed is established only between a terminal for which a user operating the terminal has been authenticated and a particular computer unit which is used by the user. The system administrator, etc. predetermines which user can use a particular computer and registers it in the access control server. Because of this configuration, a terminal for which a user is not authenticated, and a terminal for which another user has been authenticated cannot access a computer unit used by a legitimate user. Specifically, even if an attempt to connect to Terminal Services on a particular computer unit is performed, since the access to the network is blocked by the hub, the login screen is not displayed. Thus, the login is not possible. This prevents brute force attacks, dictionary attacks, and other password attacks such as an attempt to abuse an account lockout function. Furthermore, the access control system with high security can be provided, which protects the computer units from unauthorized access such as port scan attacks and DoS attacks.

It should be noted that the access control server according to the present embodiment establishes a network link only when a user operates (performs PC activities) a terminal for which the user has been authenticated. Since the network link is released during an interruption or termination of the operation of the terminal, a computer unit operated by the user does not receive a password attack from another user even when the user leaves the terminal or goes home. In addition, when the access control-server authenticates the user who uses the terminal to transmit a connection request to the access control server and when the authentication is successful, the access control server detects the terminal which is currently operated by the user and establishes a network link for the terminal. With the above configuration, the terminal operated or the environment of the network coupled with the terminal is not fixed. When, for example, the user uses a personal computer installed at home or outside home or the network environment, Terminal Services can be provided without limiting the terminal and the network environment.

According to a well-known technique, it is necessary that a system administrator manually set IP addresses assigned to terminals coupled to a network in an ACL stored in a hub. The workload for a large scale network environment is extremely high. In addition, even if the IP address assigned to the terminal is registered in the ACL stored in the hub, a user operating the terminal is not always legitimate. Furthermore, when a legitimate user does not use a computer unit, another user can illegally access the computer unit by spoofing the IP address assigned to the terminal. According to the present embodiment, the access control server detects an IP address assigned to a terminal and automatically adds the IP address to the ACL stored in the hub, which makes it easy to perform maintenance of the system. The network link according to the present embodiment is provided only to a user whose identification has been authenticated and provided only between a terminal operated by the user and a computer unit used by the user, which protects the computer unit from unauthorized access from another user.

It should be noted that the access control server 3 according to the present embodiment identifies the terminal 1, which has transmitted a connection request (F501), based on a source address included in a communication packet of the connection request that has been received by the access control server 3. Then, the access control server 3 establishes a network link between the terminal 1 and a particular computer unit that is to be used by the user who operates the terminal 1. The source address included in the communication packet is an IP address assigned to a device that has transmitted the communication packet. The source address is normally the IP address assigned to the terminal 1. The source address, however, may be replaced with an IP address assigned to a network device, depending on the network device which relays a communication packet on the network 5. In this case, the network link is established between the network device and a particular computer unit. Such a network device may be a virtual private network (VPN) server which provides an encryption function on a network.

The present embodiment described above is an example and can be applied to various modifications, which are described below.

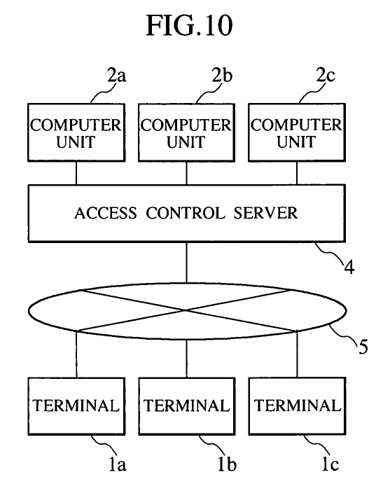

The access control system according to the present embodiment is configured so that the access control server 3 and the hub 4 are separated. With this configuration, a general purpose hub can be adopted. On the other hand, as shown in FIG. 10, the access control system may be configured so that an access control server 23 is provided by integrating the access control server 3 and the hub 4.

Although the access control server according to the present embodiment requests to add and remove an ACE through the management port of the hub, the access control server may request to add and remove an ACE through the network 5 in the case of, for example, using a hub not having a management port, which depends on the specifications of the hub.

Although the access control server according to the present embodiment specifies a particular one of the one or more terminals and a particular one of the one or more computer units by use of a source address and a destination address which are included in a communication packet, the access control server may specify the particular terminal and the particular computer unit by use of other identification information.

In the present embodiment, the network link is established by using the function for controlling whether to permit or deny the relay performed by the hub 4. The establishment of the network link may be achieved by using, for example, a function for performing communications only between a particular terminal and a particular computer unit which are coupled in a virtual LAN (VLAN), in the case where the function is provided in the hub 4. In addition, a particular computer unit having a firewall function may provide effects similar to those obtained by the abovementioned function, even if the hub is not used. If the firewall function provided in the computer unit is used, the access control server may be configured so that it requests the firewall function to perform processing (which is requested to be performed to the hub) for adding and removing an ACE and to receive a communication packet transmitted from a terminal having an IP address which is a source address included in the communication packet. Furthermore, the access control server according to the present embodiment may be operated on a particular computer unit so that the firewall function performs the processing for adding and removing an ACE.

In the present embodiment, the foregoing description has been made of the network link established by using an ACE including a source address and a destination address, the source address indicating an IP address assigned to a particular terminal, the destination address indicating an IP address assigned to a particular computer unit. With this configuration, the hub 4 relays only communication packets transmitted to a particular computer unit from a terminal for which a user operating the terminal has been authenticated. In fact, however, a communication packet may be transmitted in the opposite direction, that is, from the particular computer unit to the terminal for which the user operating the terminal has been authenticated. For the transmission in the opposite direction, when the ACE shown in FIG. 4 is generated and added in steps S605, S606 shown in FIG. 6, an ACE for the transmission in the opposite direction may be generated and added. To be specific, the ACE for the transmission in the opposite direction has a first part indicating “permit”, a second part (source address) indicating an IP address assigned to the particular computer unit and a third part (destination address) indicating an IP address assigned to the terminal. Adding the ACEs for transmission in both directions make it possible to provide a network link capable of bidirectional communications between a particular computer unit and a terminal for which the user operating the terminal has been authenticated.

In the present embodiment, a terminal is specified by use of a source address included in a communication packet so as to provide a network link. It is conceivable, however, that all the source addresses included in communication packets that are received by the hub could be the same irrespective of the terminals in the case, for example, where a proxy or a gateway is provided between the terminals and the hub. In such a case, the terminals may be specified by using another method. For example, a terminal may be specified by use of a combination of a source address and a communication port number. In general, for the hub 4, the terminal can be specified by using a combination of an IP address and a communication port number as the second or third parts of an ACE. In this case, the source address and the communication port number are described in the second part of an ACE shown in FIG. 4.

The access control server according to the present embodiment establishes a network link that is determined by both a source address and a destination address which are included in a communication packet as shown in FIG. 4, and that is set between a particular terminal and a particular computer unit. For the network link, transmission of communication packets is performed between the particular terminal and the particular computer unit using only a particular protocol in consideration of security.

Specifically, a value obtained by combining the destination address and a port number of a communication protocol that is permitted to be used may be set in the third part of the ACE shown in FIG. 4. If, for example, the use of the network link is limited to communications using Terminal Services, a port number (e.g., 3389) of Terminal Services protocol is set as shown with an ACE 75 in FIG. 16. The network link in this case can be regarded as a network link dedicated to Terminal Services. In the case of providing a network link capable of bidirectional communications, an ACE for transmission in the opposite direction may be generated and added. Specifically, an ACE 76 shown in FIG. 16 is used. The ACE 76 has a first part indicating “permit”; a second part indicating a value obtained by combining an IP address assigned to the computer unit and the port number of Terminal Service protocol; and a third part indicating an IP address assigned to the terminal. Alternatively, an ACE may be used including a first part indicating “permit”; a second part indicating the IP address assigned to the computer unit; and a third part indicating a value obtained by combining the IP address assigned to the terminal and a port number of the terminal services control unit. In this case, the access control server detects the port number of the terminal services control unit of the terminal.

For Terminal Services, all software including applications used for PC activities and various electronic files are stored in the secondary storage device of the computer unit. The software is executed by the CPU mounted in the computer unit. Only desktop screen information is transmitted from the computer unit to the terminal which is directly operated by the user. The electronic files are not transmitted to the terminal. Thus, even if the terminal is lost or stolen, information is prevented from being leaked since an electronic file containing company confidential information or personal information that should be protected is not stored in the terminal.

With the network link dedicated to Terminal Services which is established by using the ACEs as shown in FIG. 16, even if a malicious user operates a file transfer function such as a web server or a file transfer protocol (FTP) server on a certain computer unit, it is not easy to copy an electronic file located on the computer unit to a terminal. This is because the network link established between the terminal and the computer unit is dedicated to Terminal Services and prevents a communication packet transmitted by the file transfer function from being passed therethrough.

In normal communication services, bidirectional communications are performed by using predefined port numbers which are called well known port numbers. For example, Hyper Text Transfer Protocol (HTTP), which is a protocol for a web server, uses the port number 80. Since the port numbers used in the communication services can be changed, however, a malicious user may change a port number assigned to a web server to a port number for Terminal Services to make it possible to perform a file transfer between a terminal and a computer unit through a network link dedicated to Terminal Services.

In order to prevent the above, the port number used for Terminal Services may be dynamically changed.

FIG. 17 is a diagram showing examples of ACEs in the case where the port number for Terminal Services is dynamically changed.

The terminal services management unit of each of the one or more computer units 2 selects a port number to be used so as to start Terminal Services, the terminal services management unit being started by the access control server 3 in step S604. The port number may be randomly selected from private port numbers (49152 to 65535) which can be freely used. The status monitoring unit of each of the one or more computer units 2 detects that the terminal services management unit starts Terminal Services. Then, the status monitoring unit retrieves the port number and causes it to be included in a notification (F503) indicating that the start of the computer unit 2 is completed so as to transmit the notification (including the port number) to the access control server 3. After the computer unit management unit 8 confirms that the start of the computer unit 2 is completed, it retrieves a value registered in the IP address 15 within the user entries to notify the communication control unit 6 of the value and the port number included in the notification (F503).

Next, the communication control unit 6 extracts a source address from a communication packet of a connection request (F501) that has been received. Then, the communication control unit 6 passes, to the ACE setting unit 9, the IP address assigned to the computer unit 2 (which has been notified by the computer unit management unit 8) and the port number (which has been notified by the computer unit 2) to request the ACE setting unit 9 to add and set an ACE.

After being requested from the communication control unit 6, the ACE setting unit 9 generates ACEs as shown in FIG. 17 to add and set them to the hub 4 (S605, S606). Specifically, an ACE 77 has a first part indicating “permit”; a second part indicating the source address of the communication packet that has been passed; and a third part indicating the IP address assigned to the computer unit 2 and the port number that have been passed. An ACE 78 has a first part indicating “permit”; a second part indicating the IP address assigned to the computer unit 2 and the port number that have been passed; and a third part indicating the source address of the communication packet that has been passed. The ACE 78 is used for transmission in the opposite direction to transmission performed by using the ACE 77. With the ACEs 77 and 78, a network link, which is dedicated to Terminal Services and uses the port number dynamically selected, is established between the terminal 1 which has requested the connection and the particular computer unit 2 which is used by the user operating the terminal 1.

After that, the communication control unit 6 returns, to the terminal 1, a notification (F505) indicating that the connection is prepared and can be established, the IP address assigned to the computer unit 2 which has been notified from the computer unit management unit 8, and the port number which has been notified from the computer unit 2 (S608).

When the terminal 1 receives the notification (F505), the computer unit control program of the terminal 1 transmits, to the terminal services control unit, the IP address and the port number which have been notified. The terminal services control unit uses the IP address and the port number to transmit, to the computer unit 2, a request (F506) for connection to Terminal Services. Then, the user enters a user ID and a password on the login screen and then receives Terminal Services to perform PC activities.

Furthermore, in step S603, the access control server 3 according to the present embodiment requests the terminal services management unit of the computer unit 2 to change the port number even when the computer unit 2 is already started. In other words, the port number for Terminal Services is dynamically changed each time the access control server 3 receives a connection request from the terminal 1 irrespective of whether or not the computer unit 2 is started.

In the example as shown in FIG. 17, a network link dedicated to communications over a port number 54321 is established, the port number 54321 being dynamically assigned by the terminal services management unit of the computer unit 2. Thus, even if a malicious user changes the port number assigned to the web server on the computer unit 2 to a well known port number (e.g., 3389) for Terminal Services, a file transfer is not possible. In addition, even if a user obtains the port number that has been dynamically assigned and changes the port number assigned to the web server to the dynamically assigned port number, the user cannot access the web server. This is because the port number assigned to the network link is changed when the user attempts to connect to the computer unit 2 after the user changes the port number assigned to the web server. As described above, the port number used for Terminal Services is dynamically changed each time a connection is established, which makes it possible to establish the network link capable of preventing information from being leaked.

In order to facilitate business activities, the system may be configured so that a file transfer from a certain computer unit 2 to a certain terminal 1 is permitted when the user is in the office and that the file transfer is not permitted when the user is out of the office. In order to support this case, ACEs may be set so that establishment of a network link is permitted or denied depending on the location of the terminal 1 coupled. Specifically, as an ACE with a search priority lower than an ACE added by the access control server 3, a first ACE is added, which has a first part indicating “deny”; a second part indicating an IP address (IP addresses) assigned to the VPN server; and a third part indicating no IP address and indicating a communication port number used to provide a file transfer service. In addition, as an ACE with a search priority lower than the first ACE, a second ACE is added, which has a first part indicating “permit”; a second part indicating no IP address; and a third part indicating no IP address and indicating the communication port number used to provide the file transfer service. Those ACEs are preset to the hub 4 by the system administrator or the like.

When the user is out of the office, the user uses the terminal 1 to connect it to the access control system through the VPN server in many cases. In general, the VPN server maintains a pool of IP addresses and assigns one of the IP addresses to the terminal 1 that is coupled to the access control system. Then, the VPN server replaces the source address included in the communication packet received from the terminal 1 with the IP address assigned so as to transfer it to a corporate network. For this reason, it is necessary that the first ACE be added for each address included in the pool of the VPN server. Alternatively, a group of IP addresses included in the pool of the VPN server may be collectively described in the ACEs by using a wild card. Furthermore, the ACE may be configured so that the source address included in the communication packet received from the terminal 1 is used without being replaced with the IP address included in the pool of the VPN server to determine whether to permit or deny the establishment of the network link.

With the above configuration, the communication packet, which is transmitted from the terminal 1 and used to perform a file transfer, is blocked by the first ACE when the user is out of the office, and is transferred to the computer unit 2 by the second ACE when the user is in the office. As described above, the access control server determines the location of the terminal and changes the communication port that is permitted for the network link in accordance with the location that has been determined so as to provide services based on the location of the user.

The access control server according to the present embodiment provides the network link between a particular terminal and a particular computer so that terminals other than the particular terminal cannot access the particular computer through the network. However, the following case is conceivable: the computer unit is required to accept another communication protocol such as a protocol for the web server.

In addition, for current PC activities, application programs used to communicate with another computer, such as web pages and emails, are essential. According to the present embodiment, Terminal Services is applied. In this case, it is necessary that each computer unit communicates with other computers. When the other computers are coupled on the network 5, the network link must be established so that it does not interrupt communications of the application programs.

In order to support the abovementioned two cases, as an ACE with a search priority lower than an ACE added by the access control server 3, an ACE may be added, which has a first part indicating “deny”; a second part indicating no IP address; and a third part indicating a combination of an IP address assigned to each computer unit (or no IP address) and a communication port number used to provide Terminal Services. Together with the above ACE, an ACE with a first part indicating “permit” may be registered as a default ACE. Alternatively, as an ACE with a search priority lower than an ACE added by the access control server 3, an ACE may be added, which has a first part indicating “permit”; a second part indicating no IP address; and a third part indicating a combination of an IP address assigned to the web server or mail server and the communication port number. Together with the ACE, an ACE with a first part indicating “deny” may be registered as a default ACE. These ACEs are preset to the hub 4 by the system administrator and the like. With the ACEs, terminals other than the particular terminal cannot be coupled to Terminal Services; or cannot perform the login. This ensures a function for preventing unauthorized access while allowing for communications other than Terminal Services between the computer unit and other computers.

In the case of the setting described above, a magic packet which starts the computer unit is passed. Thus, there is a possibility that the computer unit can be started from any of the terminals as long as the MAC address assigned to the computer unit is identified, which requires additional support.

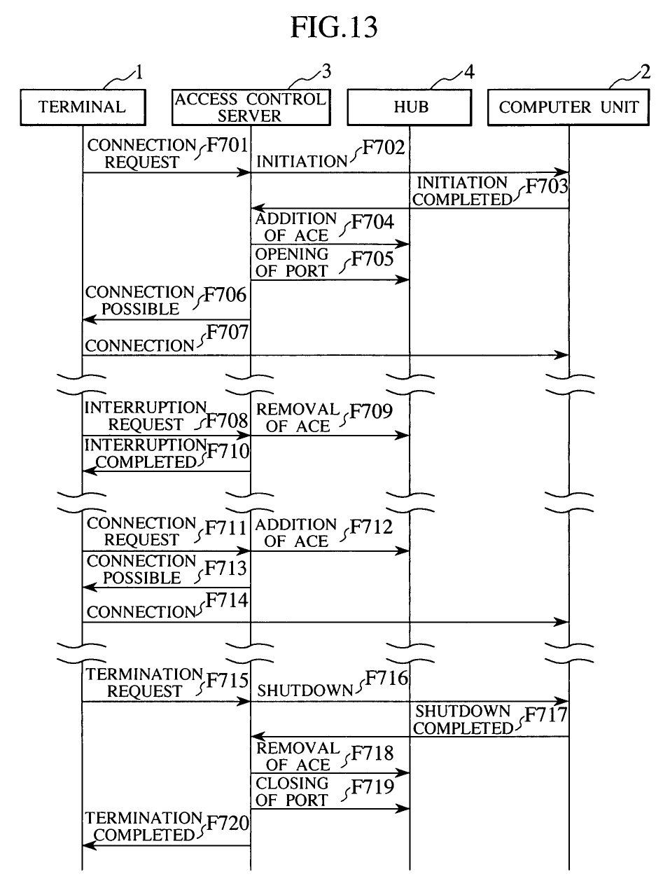

FIG. 13 is a diagram showing a modified example of the communication sequences shown in FIG. 5 to support the abovementioned case. In the example, in addition to the filtering of communication packets by use of an ACE, ports of the hub are controlled to be opened and closed, each of the ports being coupled to a computer unit. In this case, each of the ports of the hub is not a communication port used in TCP and UDP, but is a jack to which a network cable is inserted. Furthermore, in this case, the port is opened to obtain the state where it can be electrically coupled, and is closed to obtain the state where it cannot be electrically coupled.

The access control server 3 receives a connection request (F701) from the terminal 1 and confirms the identification of the user. Then, the access control server 3 starts the computer unit 2 (F702). After that, the access control server 3 adds an ACE to the hub 4 (F704) and requests the hub 4 to open a port coupled to the computer unit 2 (F705). When the access control server 3 receives a termination request (F715) from the terminal 1, it shuts down the computer unit 2 (F716). After that, the access control server 3 removes the added ACE (F718) and requests the hub 4 to close the port (F719), which has been opened in F705. The number of the port is used for instruction to open and close the port, for example. For this reason, an area for storing the number of the port coupled to the computer unit is provided in each of the computer unit management tables 12. This can prevent the computer unit 2 from being illegally started.

In addition, while the user interrupts PC activities, control may be changed so that the port is closed if it is not necessary that the computer unit 2 communicates with another device. For example, the terminal 1 transmits an interruption request (F708) to the access control server 3. Then, the access control server 3 removes the ACE (F709) that has been added in F704 and then requests the hub 4 to close the port that has been opened in F705. When the access control server 3 receives a connection request (F711) transmitted from the terminal 1 again, the access control server 3 adds an ACE (F712) and then requests the hub 4 to open the port that has been closed. In addition, the same effect as the above case can be obtained when the port is closed in F709 instead of removing the ACE and the port is opened in F712 instead of adding the ACE.

Although P2P type Terminal Services is described as an example in the present embodiment, SBC type Terminal Services may be applied to the present embodiment. A user who is not authenticated cannot attempt to connect to SBC type Terminal Services. In the case of SBC type Terminal Services, a plurality of users share a single computer unit. It is appropriate that a group consisting of several tens of users is assigned to a single computer unit as users who can share the computer unit. With this configuration, a user not belonging to a certain group cannot access a particular computer unit. In addition, privacies of the users can be protected by identifying communication data for each user. In the present embodiment, services can be provided between a plurality of users and a particular plurality of computer units. In this case, information used to specify the computer units which are to be accessed may be added.

It should be noted that, since known Terminal Services allows data to be transmitted and received between a terminal and a remote computer through a network, if data cannot be transmitted or received due to a failure of the network or the like, a communication session for Terminal Services is decoupled. After the network is recovered, the user uses the terminal to reconnect it to Terminal Services on the remote computer used and then can restart PC activities. If, however, the user leaves the terminal without performing the interruption process of the present embodiment when Terminal Services cannot be used due to a failure of the network or the like, there is a possibility that another user may use the terminal which has been used by the abovementioned user to perform a password attack to the computer unit after the network is recovered.

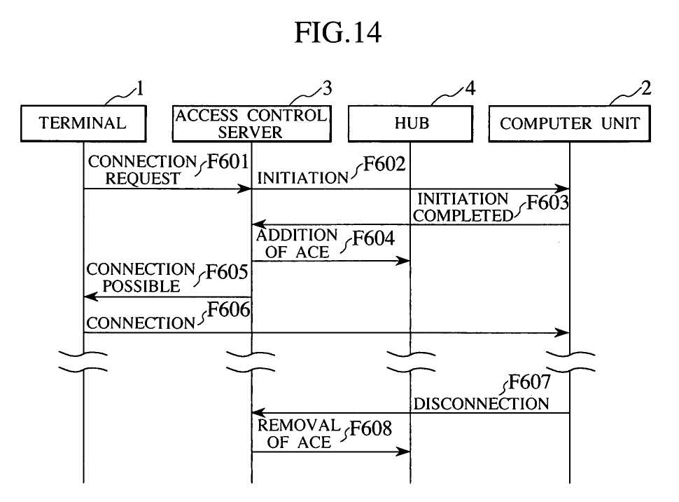

FIG. 14 is a diagram showing a modified example of the communication sequences shown in FIG. 5 in order to support the abovementioned case. In this example, when communications cannot be performed between the terminal and the computer unit, the network link established is released.

The status monitoring unit of each of the computer units 2 monitors the status of communications with the terminal 1. When the status monitoring unit detects that communications with the terminal 1 are decoupled, it notifies the access control server 3 of the fact (F607). After receiving the notification indicating the disconnection, the access control server 3 requests the hub 4 to remove the ACE (F608) that has been added and set in F604 so as to release the network link set between the terminal 1 and the computer unit 2, similarly to the procedure shown in FIG. 7. This can prevent unauthorized access to the computer units after the recovery of the network.

Using a general Terminal Services client (the terminal services management unit shown in FIG. 11), the user can disconnect a Terminal Services communication session with a remote computer. In the present embodiment, when the user leaves the terminal 1, the user operates the computer unit control program of the terminal 1 to transmit an interruption request to the access control server 3. If, however, the user operates the terminal 1 to disconnect the Terminal Services communication session before transmitting the interruption request, the network link is maintained without being released. Although another terminal cannot access a corresponding computer unit, it is desirable that the network be released for security when Terminal Services is not used because of potential unauthorized access. In order to support this case, the following function may be added to the computer unit control program of the terminal 1. That is, the function is to monitor the Terminal Services communication session with the remote computer and to, when detecting the disconnection, automatically transmit the interruption request to the access control server 3. Alternatively, when the status monitoring unit of the computer unit 2 detects the disconnection of the Terminal Services communication session, it may notify the access control server 3 of the fact. This provides a similar effect to the above case.

According to the present embodiment, the hub blocks unauthorized access to the computer units. If the system is configured so that information (IP address assigned to a terminal, communication packet, protocol, etc.) on unauthorized access that has been blocked by the hub is notified to the system administrator, the system administrator can immediately take measures against the unauthorized access. This makes it possible to build the system with higher security. The notification on unauthorized access may be performed to the system administrator by using a function of the hub. Alternatively, if the hub does not have the function, the access control server may extract information from logs stored in the hub so as to notify the system administrator of the information.

Although the access control server according to the present embodiment uses TLS for user authentication, another technique may be used as long as the identification of the user can be authenticated. For example, biological authentication which uses characteristics specific to human bodies is effective, such as fingerprint authentication, iris authentication, and finger vein authentication.

Each of the computer units according to the present embodiment is a general purpose computer or the like having a CPU, hard disk, LAN card, etc. mounted in a housing. However, since the role of the computer unit according to the present embodiment is to provide Terminal Services, the housing is not always necessary. A board having a CPU, hard disk, LAN card, etc. mounted thereon may be adopted without the housing. Such a board is called a blade computer. Recently, blade computers have been implemented in various systems, and may be applied to the computer units according to the present embodiment.

Although the computer unit is started by using a magic packet in the present embodiment, another technique may be used for the start. For example, if the computer unit supports Intelligent Platform Management Interface (IPMI), the start can be realized by using IPMI.

According to the present embodiment, since the access control server detects that each of the computer units is completely started or shut down, each of the computer units is provided with the status monitoring unit. The access control server may monitor the status of each of the computer units. For example, the access control server transmits an Internet Control Message Protocol (ICMP) echo request to each of the computer units. Then, the access control server may determine that a corresponding computer unit is completely started if the access control server receives a response to the request, and that the corresponding computer unit is shut down if the access control server does not receive the response to the request. In addition, the access control server may determine that a corresponding computer unit is completely started if the access control server transmits a TCP connection request and receives a response to it, and that the corresponding computer unit is shut down if the access control server does not receive the response to it.

The access control server according to the present embodiment confirms the operation status of corresponding one of the computer units when the access control server receives a connection request from the terminal. If the computer unit is not started, the access control server starts the computer unit. After the computer unit is completely started, the access control server notifies the terminal of the fact that the connection to Terminal Services is completely prepared. After receiving the notification, the terminal starts the connection to Terminal Services on the computer unit. Since it takes several tens of seconds to several minutes to start a typical computer unit, however, it is preferable that the user be notified of the fact that the computer unit is being started. To support the above, the following operation may be added. That is, the operation is to notify the terminal 1 of the fact that a particular computer unit is being started before the particular computer unit is started (S604 shown in FIG. 6). When the terminal 1 receives the notification, it displays on the display 42 a message indicating that, for example, “Starting the computer, please wait”.

According to the present embodiment, IP addresses assigned to each of the computer units are pre-registered in the management database by the system administrator. For this operation, it is assumed that the system is configured so that a fixed IP address is assigned to each computer unit. On the other hand, the system may be configured so that an IP address is dynamically assigned to each of the computer units. In this configuration, a Dynamic Host Configuration Protocol (DHCP) server is used in general. To support IP addresses which are dynamically assigned in the present embodiment, when a particular one of the computer units 2 is started, the status monitoring unit may detect an IP address assigned by the DHCP server and add the IP address to the notification (F503) indicating that the start of the computer unit 2 is completed so as to transmit it to the access control server 3. After receiving the notification, the access control server 3 stores the value of the IP address into an IP address area in the management database 10. The value is referenced in subsequent processes.

Within recent years, a lot of computers have been infected with viruses. If a computer such as a personal computer is infected with a virus, it is necessary that the infected computer be decoupled with a network and the virus be removed. Otherwise, the virus may be spread to other computers, which results in a secondary infection. The access control server according to the present embodiment can solve such a problem.

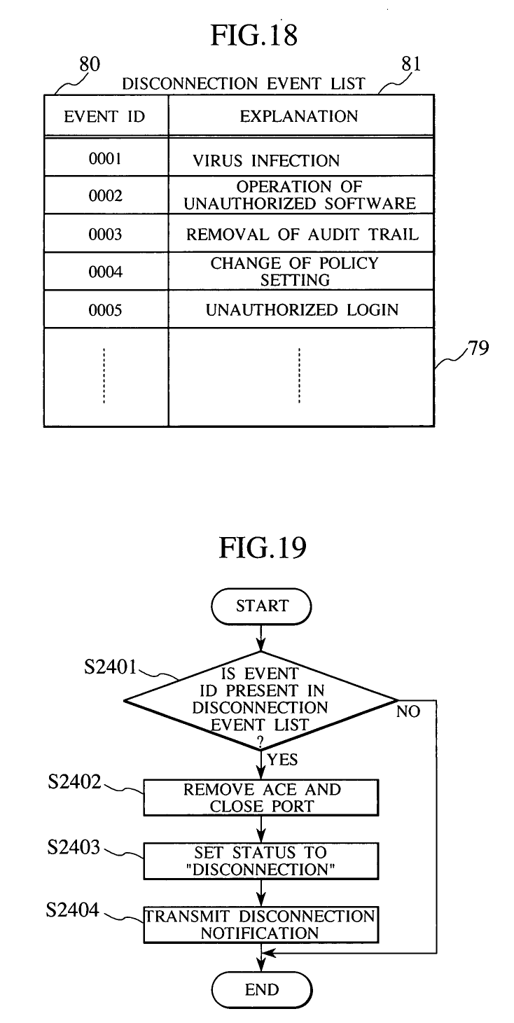

To support the above case, a disconnection event list 79 as shown in FIG. 18 is added to the management database 10. The disconnection event list 79 includes an event ID 80 and an explanation 81. The event ID 80 is used to uniquely identify an event that occurs on a certain computer unit, and the explanation 81 is used to explain the event.

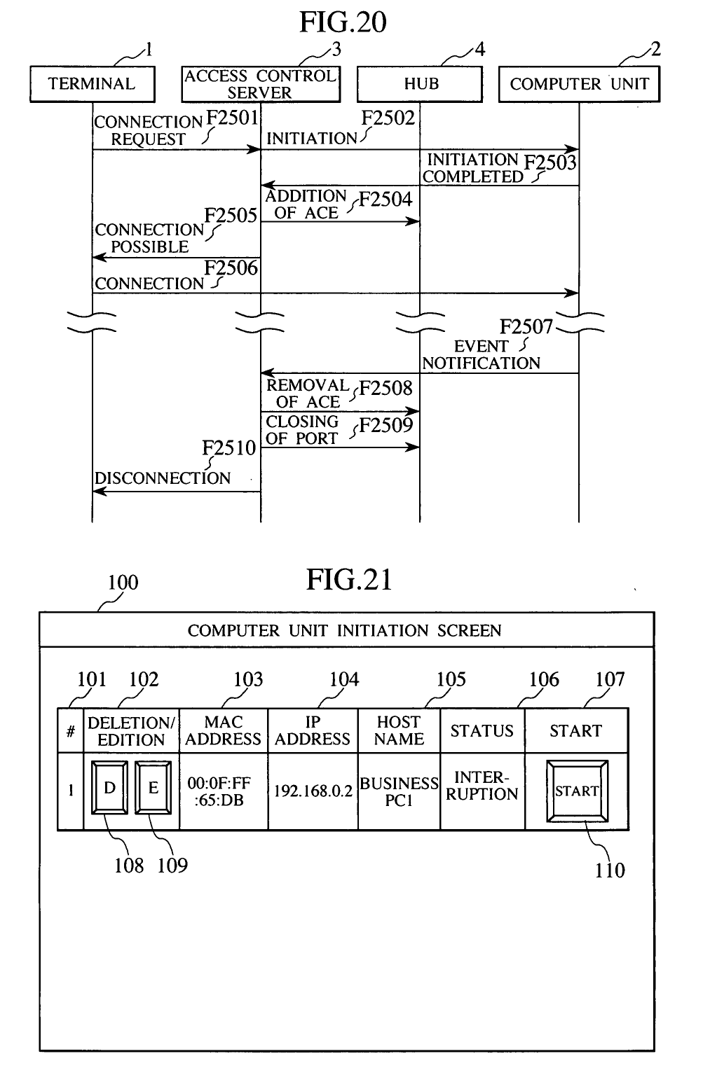

Each time the status monitoring unit of each of the computer units 2 detects one of various events that occur on the corresponding computer unit 2, the status monitoring unit transmits an ID (event ID) assigned to the event to the access control server 3. When the access control server 3 receives the event ID from the computer unit 2, it performs a process shown in FIG. 19. FIG. 20 shows an example of a communication sequence of the process.

The user uses the terminal 1 to connect it to Terminal Services on the computer unit 2 (F2506). If the status monitoring unit of the computer unit 2 detects an event such as a virus infection while the user performs PC activities, it transmits, to the access control server 3, an event notification (F2507) including an ID (event ID) assigned to the event that has occurred. The communication control unit 6 of the access control server 3 receives the event notification and notifies the computer unit management unit 8 of the event ID. The computer unit management unit 8 refers to event IDs 80 of the disconnection event list 79 in order, and notifies the communication control unit 6 of whether or not the notified event ID is present. If the event ID is present in the disconnection event ID 79 (S2401), the communication control unit 6 requests the ACE setting unit 9 to remove a corresponding ACE and close a corresponding port (S2402, F2508, F2509), and requests the computer unit management unit 8 to change the value of the status 16 within the user entries so that the status 16 indicates “disconnection” (S2403). In addition, the communication control unit 6 transmits, to the terminal 1, a disconnection notification (F2509) indicating the network link has been released (S2404). On the other hand, if the event ID that has been notified in F2507 is not present in the disconnection event ID 79 in step S2401, the event is determined so that the disconnection is not necessary and steps S2402 to S2404 are skipped. That is, the network link is maintained without being decoupled.

Adding the disconnection event list 79 (shown in FIG. 18) and the process (shown in FIG. 19) for detecting an event enables a certain computer unit to be automatically decoupled from the network if the computer unit is infected with a virus. This makes it possible to prevent a secondary infection to other computers. In above mentioned case, the description is made taking a virus infection as an example. Also, in the case where various events other than virus infections occur, the computer unit can be automatically decoupled from the network in a similar manner. For example, as shown in the disconnection event list 79 of FIG. 18, the computer unit can be automatically decoupled from the network so that the computer unit cannot be operated by the user if any one of the following events regarded as unauthorized use is detected: unauthorized software that is not permitted to be used is installed or operated; various logs that are output for the purpose of audit are removed; setting information such as a management policy is changed; in a domain environment in which user accounts of computer units are centrally managed, the login is performed by using a local account of a certain computer unit; or the like.

In the above modified example, the status monitoring unit operating on the computer unit notifies the access control server of the occurrence of the event. If, however, the status monitoring unit is forcibly stopped by the user, the occurrence of an event is not notified to the access control server. Thus, the network link cannot be released. To support this case, the access control server may periodically communicate with the status monitoring unit, and the process may be changed so that the access control server receives a notification indicating the occurrence of an event. If the status monitoring unit is forcibly stopped to disconnect the communications, access control server performs a process for disconnecting the network link in a similar manner to steps S2402 to S2404.

Although the access control system is configured so that a single access control server is provided in the present embodiment, two or more access control servers may be provided for redundancy in order to configure the system with high reliability, which is, for example, capable of fault tolerant operation. In addition, if the access control server cannot operate due to a failure of a device implementing the access control server or the like, it may be switched to another server to continue to provide services. Furthermore, if the single access control server lacks sufficient processing capability for a large scale system having a lot of users, a plurality of the access control servers may be concurrently operated. In this case, in order to level the load applied to the access control servers, each terminal may transmit a request to one of the access control servers which has the least load among the access control servers. Alternatively, a load distribution device may be provided between the access control servers and the network.

### Second Embodiment

The process shown in FIGS. 5 and 6, which is performed to start a certain one of the computer units 2, may be interactively performed in the form of a web page after the terminal 1 is completely coupled to the access control server 3. Specifically, the user operates the computer unit control program 47 of the terminal 1 to access the access control server 3 which provides a control screen 100 (which is in the form of a web page) in order to request the access control server 3 to connect the terminal 1 to a certain one of the computer units 2. The computer unit management unit 8 of the access control server 3 transmits the control screen 100 to the terminal 1. Then, the computer unit control program 47 displays the control screen 100. The process for displaying the control screen 100 in the form of a web page can be achieved by using a well-known technique.

FIG. 21 is a diagram showing an example of the control screen 100. When accessing the web page, the user uses TLS for connection. Using TLS allows the terminal 1 to detect that the web page is correct and allows the access control server 3 to confirm that the user is legitimate. A procedure for authentication using TLS is similar to that in the first embodiment.

The control screen 100 shown in FIG. 21 is a table including: an item number 101; a field 102 including buttons for deletion, edition and the like; a field 103 for indicating an MAC address assigned to the computer unit 2; a field 104 for indicating an IP address assigned to the computer unit 2; a field 105 for indicating a name of the computer unit 2 when the computer unit 2 is named; a status field 106 for indicating whether or not the computer unit 2 is operated; a field 107 including a button for instructing start; and the like.

In the field 102 including buttons for deletion, edition and the like, a deletion button 108 for removing a corresponding item, a edition button 109 for editing a corresponding item, and the like are provided. In the field 107 including a button for instructing start, an start button 110 is provided.

The user confirms the status field 106 for indicating the operation status of the computer unit 2 used by the user. If the status field 106 indicates the computer unit 2 stops, the user presses the start button 110 to start the computer unit 2.

Since the IP address and the MAC address, which are assigned to the computer unit 2, are described in the user management table 11 and the computer unit management table 12 shown in FIG. 3, the computer unit management unit 8 may search the IP address and the MAC address to display them in the fields 103 and 104, respectively. In this case, the edition button 109 is not necessary.

In the case where a single user uses a plurality of the computer units 2, items for the plurality of the computer units 2 are displayed as a single entry. If any of the plurality of the computer units 2 is not used, the user may use the deletion button 108 to remove a corresponding item.

In the present embodiment, the operation for the connection request F501 shown in FIG. 5 corresponds to an operation for connecting the terminal 1 to the access control server 3 and an operation for displaying the control screen 100 shown in FIG. 21, the control screen 100 being provided in the terminal 1. The operation for the start F502 corresponds to an operation by pressing the displayed start button 110 by the user.

With the above operations, the computer unit 2 having an IP address which is assigned thereto and specified in the field 104 is started from a port for a MAC address specified in the field 103. When the start of the computer unit 2 is completed, the computer unit 2 transmits, to the access control server 3, the notification F503 indicating the start is completed. Then, the access control server 3 changes the status field 106 to indicate “starting” so as to notify the user of it. The operation for the notification to the user corresponds to the operation for the notification (F505) indicating the connection is completely prepared, as shown in FIG. 5. The user confirms the notification (F505), and the terminal 1 used by the user can connect to Terminal Services on the computer unit 2 (F506). After that, the same operations as those shown in FIG. 5 are performed.

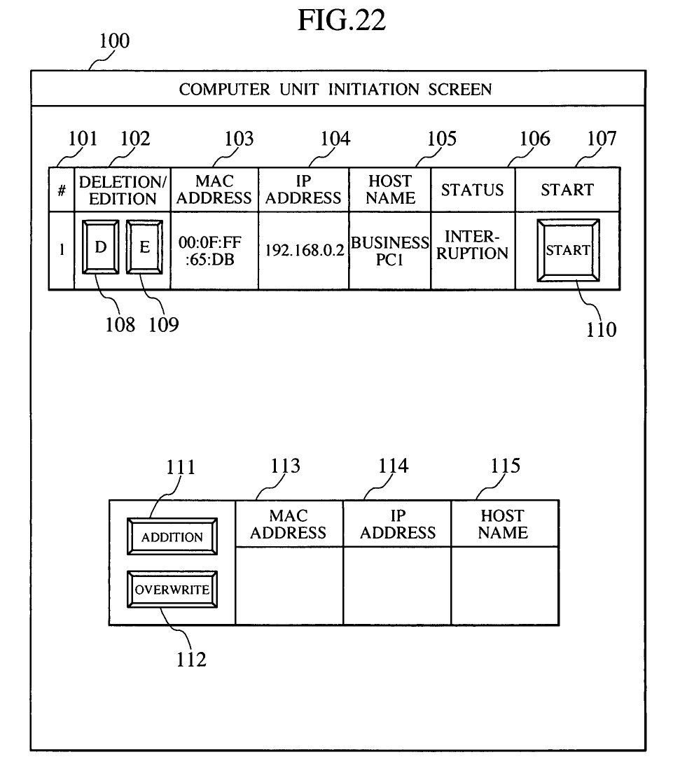

The operation for adding an ACE (F504) corresponds to the following operation: when the user presses the edition button 109 (for editing a corresponding item) in the control screen 100, the computer unit management unit 8 additionally displays a MAC address edition field 113, an IP address edition field 114, and a host name edition field 115 as shown in FIG. 22. In those fields, the user can enter data. The user presses an addition button 111 in the case where a computer unit is added. The user presses an overwrite button 112 to modify existing data.

Such a function, which is in the form of a web page and provided in the access control server 3, can be achieved by using an existing web page server. Therefore, a dedicated access control server is not necessary in the present embodiment.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. An access control system comprising:
one or more computer units;
one or more terminals coupled with the one or more computer units through a network and a hub that controls access from the one or more terminals to the one or more computer units; and
an access control server that controls the hub;
wherein the access control server authenticates a user who operates one of the one or more terminals; and
the access control server sets, in accordance with the result of the authentication, the hub so that a network link for a particular protocol is established between the terminal operated by the user and a particular one of the one or more computer units.

2. The access control system according to claim 1,
wherein the access control server controls start of the particular computer unit in accordance with the result of the authentication.

3. The access control system according to claim 1,
wherein, when the access control server determines that the user is legitimate in accordance with the result of the authentication, the access control server provides, to the terminal, a control screen that allows the user to control an operation of the particular computer unit;
the terminal displays the control screen and receives an instruction given to the control screen from the user to transmit the instruction to the access control server; and
the access control server controls the start of the particular computer unit in accordance with the instruction given from the user.

4. The access control system according to claim 1,
wherein the access control server determines a communication port number assigned to the particular protocol and sets, in the hub, access permission of the communication port number that has been determined for establishment of the network link for the particular protocol.

5. The access control system according to claim 4,
wherein the particular computer unit selects a communication port number used for the network link to notify the access control server of the communication port number; and
the access control server sets, in the hub, access permission of the communication port number notified from the computer unit as the communication port number to be assigned to the particular protocol for establishment of the network link for the particular protocol.

6. The access control system according to claim 5,
wherein the particular computer unit randomly selects the communication port number to be notified.

7. The access control system according to claim 4,
wherein the access control server determines a location where the terminal is coupled with the network based on an address assigned to the network to which the terminal is coupled; and
the access control server determines the communication port number to be assigned to the particular protocol of the network link for establishment of the network link for the particular protocol based on the location that has been determined.

8. The access control system according to claim 1,
wherein the access control server monitors an event that may occur in the particular computer; and
when the access control server detects the occurrence of an predetermined event, the access control server sets the hub so that the network link between the particular computer unit and the terminal operated by the user is released.

9. An access control server used in an access control system including one or more computer units, one or more terminals coupled with the one or more computer units through a network and a hub that controls access from the one or more terminals to the one or more computer units, the access control server controlling the hub, the access control server comprising:
a unit for authenticating a user who operates one of the one or more terminals; and
in accordance with the result of the authentication, a unit for setting the hub so that a network link for a particular protocol is established between the terminal operated by the user and a particular one of the one or more computer units.

10. The access control server according to claim 9, wherein the same determines a communication port number assigned to a particular protocol and sets, in the hub, access permission of the communication port number that has been determined for establishment of a network link for the particular protocol.

11. The access control server according to claim 10, wherein the same sets, in the hub, access permission of a communication port number notified from the particular computer unit for which the network link is established as the communication port number to be assigned to the particular protocol for establishment of the network link for the particular protocol.

12. The access control server according to claim 10, wherein the same determines a location where the terminal is coupled with the network based on an address assigned to the network and determines the communication port number to be assigned to the particular protocol of the network link based on the location that has been determined for establishment of the network link for the particular protocol.

13. The access control server according to claim 9, wherein the same monitors an event that may occur in the particular computer unit and, when detecting the occurrence of a predetermined event, sets the hub so that the network link between the particular computer unit and the terminal operated by the use is released.
